(19) United States
(12) Patent Application Publication
(10) Pub. No.: US 2020/0037203 A1
(43) Pub. Date: Jan. 30, 2020

(54) USER EQUIPMENT, SYSTEM AND COMMUNICATION METHOD FOR MANAGING OVERLOAD IN THE CONTEXT OF CONTROL PLANE CELLULAR INTERNET OF THINGS EVOLVED PACKET SYSTEM OPTIMISATION

(71) Applicant: NEC Corporation, Tokyo (JP)

(72) Inventors: Iskren IANEV, Heidelberg (DE); Genadi VELEV, Heidelberg (DE); Toshiyuki TAMURA, Tokyo (JP); Andreas KUNZ, Heidelberg (DE)

(73) Assignee: NEC Corporation, Tokyo (JP)

(21) Appl. No.: 16/338,274

(22) PCT Filed: Sep. 13, 2017
(86) PCT No.: PCT/JP2017/032995

§ 371 Date: Mar. 29, 2019

(30) Foreign Application Priority Data
Oct. 10, 2016 (EP) 16193159.7

(51) Int. Cl. H04W 28/02; H04W 28/06

(52) U.S. Cl. CPC H04W 28/0289; H04W 84/18; H04W 28/06; H04W 28/0247

(57) ABSTRACT

This disclosure provides a User Equipment (UE) (3), including a receiver (31) and a controller (34). The receiver (31) is configured to receive a control plane data back-off timer included in a Service Accept message from a network. The controller (34) is configured to consider a current data transfer via a control plane as successful based on the Service Accept message and not to initiate data transfer via Control Plane Cellular Internet of Things (CIoT) Evolved Packet System (EPS) Optimization while the control plane data back-off timer is running.

### TECHNICAL FIELD

The present disclosure relates to a communication system. The disclosure has particular but not exclusive relevance to wireless communication systems and devices thereof operating according to the 3rd Generation Partnership Project (3GPP) standards or equivalents or derivatives thereof.

### BACKGROUND ART

Under the 3GPP standards, a ‘NodeB’ (or an evolved NodeB (‘eNodeB’/‘eNB’) in Long Term Evolution (LTE)) is the base station via which mobile devices connect to a core network and communicate to other mobile devices or remote servers. In order to be able to do so, the mobile devices establish a so called radio resource control (RRC) connection with a serving base station. For simplicity, the present application will use the term base station to refer to any such base stations. Communication devices might be, for example, mobile communication devices such as mobile telephones, smartphones, user equipments, personal digital assistants, machine type communication (MTC) devices, laptop computers, web browsers, and the like. 3GPP standards also make it possible to connect non-mobile user equipment to the network, such as Wi-Fi routers, modems, which can be implemented as a part of a (generally) stationary apparatus.

Under the 3GPP standards, base stations are coupled to a core network (referred to as an enhanced packet core (EPC) network in LTE). In order to keep track of the mobile devices and to facilitate movement between the different base stations, the core network comprises a number of mobility management entities (MMEs) or serving General Packet Radio Service (GPRS) support nodes (SGSNs) which are in communication with the base stations coupled to the core network. Communication between the mobile devices and their associated MME/SGSN is carried out using non-access stratum (NAS) signalling (via the serving base station).

3GPP has been studying the architecture enhancements to support ultra-low complexity, power constrained, and low data-rate MTC devices referred to as ‘Cellular Internet of Things’ (CIoT) devices. The main focus of the work in 3GPP is to support highly efficient handling of infrequent small data transmissions with minimised overhead for system signalling without compromising e.g. security.

Effectively, the Internet of Things is a network of devices (or “things”) equipped with appropriate electronics, software, sensors, network connectivity, and/or the like, which enables these devices to collect and exchange data with each other and with other communication devices. For simplicity, the present application refers to user equipments (UEs) or mobile devices in the description and the figures (in the context of CIoT devices) but it will be appreciated that the technology described can be implemented on any mobile and “non-mobile” equipment that can connect to such a core network.

The following architectural enhancements for improved support for small data transfer have already been achieved within 3GPP Rel-13 NB-IoT work:
User Plane CIoT Evolved Packet System (EPS) Optimization—based on optimized User Plane transport of data;
Control Plane CIoT EPS Optimization—transports user data via the MME by encapsulating user data in NAS Protocol Data Units (PDUs), reducing the total number of control plane messages when handling a short data transaction.

When attaching or re-attaching (Attach, Routing Area Update (RAU)/Tracking Area Update (TAU)) to a network, a narrowband Cellular Internet of Things (NB-CIoT) UE or a wideband Cellular Internet of Things (WB-CIoT) UE includes in a Preferred Network Behavior indication the Network Behavior the UE can support and what the UE would prefer to use. The Preferred Network Behavior includes this information:
whether Control Plane CIoT EPS Optimization is supported;
whether User Plane CIoT EPS Optimization is supported;
whether Control Plane or User Plane CIoT EPS Optimization is preferred;
whether S1-U data transfer is supported;
whether Short Message Service (SMS) transfer without Combined Attach is requested;
whether Attach without packet data network (PDN) Connectivity is supported;
whether header compression for Control Plane CIoT EPS Optimization is supported.

The MME indicates the network behavior which the MME accepts, in the Supported Network Behavior information. The MME may indicate one or more of the following:
whether Control Plane CIoT EPS Optimization is supported;
whether User Plane CIoT EPS Optimization is supported;
whether S1-U data transfer is supported;
whether SMS transfer without Combined Attach is accepted;
whether Attach without PDN Connectivity is supported;
whether header compression for Control Plane CIoT EPS Optimization is supported.

A UE that supports NB-IoT shall always indicate support for Control Plane CIoT EPS Optimization (i.e Control Plane CIoT EPS Optimization support is mandatory).

If a UE includes a Preferred Network Behavior, the Preferred Network Behavior defines the Network Behavior the UE is expecting to be available in the network.

When selecting an MME for a UE that is using the NB-IoT Radio Access Technology (RAT), and/or for a UE that signals support for CIoT EPS Optimization in RRC signalling, the eNodeB's MME selection algorithm shall select an MME taking into account the MME's support (or non-support) for the Release 13 NAS signalling protocol.

Data Transfer in Control Plane CIoT EPS Optimization

If the UE and the MME use the Control Plane CIoT EPS Optimization, they can transfer data in NAS PDUs including the EPS Bearer Identity of the PDN connection they relate to. Both the IP and Non IP data types are supported. This is accomplished by using the NAS transport capabilities of RRC and S1 application protocol (S1-AP) protocols and the data transport of GPRS Tunneling Protocol for User Plane (GTP-u) tunnels between a MME and a Serving Gateway (S-GW) and between a S-GW and a PDN Gateway (P-GW), or if a Non-IP connection is provided by via the MME with the Service Capability Exposure Function (SCEF), then data transfer occurs as indicated in TS 23.682. To minimize potential conflicts between NAS signaling PDUs and NAS Data PDUs, the MME should complete any security related procedures (e.g. Authentication, Security Mode Command, Globally Unique Temporary UE Identity (GUTI) reallocation) before alerting the home subscriber server (HSS), mobile switching center (MSC) or S-GW 11 of the UE's entry into EPS connection management (ECM)-CONNECTED state, and before commencing downlink transfer of NAS Data PDUs.

FIG. 1 (which is reproduced from 3GPP Technical Specification (TS) 23.401, section 5.3.4B.2) shows Mobile Originated data transfer via Control Plane CIoT EPS Optimization.

FIG. 2 (which is reproduced from 3GPP TS 23.401, section 5.3.4B.3) shows Mobile Terminated data transfer via Control Plane CIoT EPS Optimization.

### SUMMARY OF INVENTION

### Technical Problem

The data transmission via Control Plane CIoT EPS Optimization in 3GPP Rel-13 is expected to add an extra load to the network control plane entities like MME and SGSN which are used to handle signalling messages that are relatively smaller compared to the data that MME and SGSN should handle with the deployment of the Control Plane CIoT EPS Optimization. That is why in Rel-14 the 3GPP has continued to study further architecture enhancement to support Cellular Internet of Things (CIoT). One of the Key issues identified in the 3GPP Rel-14 study (Technical Report TR 23.730) is the core network (CN) overload protection for UE supporting control plane EPS CIoT Optimization which requires from the system to support procedures to handle the CN overload from data transmission via Control Plane CIoT EPS Optimization.

### Solution of Problem

Problem Statement: The Control Plane CIoT data transfer can contribute greatly for the MME/SGSN overload if an appropriate load control with emphasis on communication via Control Plane CIoT is not put in place. The solution proposals are looking at how to further improve the system (e.g the MME/SGSN or the SCEF or the S-GW/P-GW) overload control from excessive use of Control Plane CIoT EPS Optimization for data transfer.

In an exemplary aspect of the disclosure, there is provided a User Equipment (UE), comprising: a receiver configured to receive a control plane data back-off timer included in a Service Accept message from a network; and a controller configured to consider a current data transfer via a control plane as successful based on the Service Accept message and not to initiate data transfer via Control Plane Cellular Internet of Things (CIoT) Evolved Packet System (EPS) Optimization while the control plane data back-off timer is running.

In another exemplary aspect of the disclosure, there is provided a communication method of a User Equipment (UE), comprising: receiving a control plane data back-off timer included in a Service Accept message from a network; and considering a current data transfer via a control plane as successful based on the Service Accept message and not to initiate data transfer via Control Plane Cellular Internet of Things (CIoT) Evolved Packet System (EPS) Optimization while the control plane data back-off timer is running.

In another exemplary aspect of the disclosure, there is provided a non-transitory computer readable medium storing instructions operable to program a programmable processor for a User Equipment (UE) to perform a method comprising: receiving a control plane data back-off timer included in a Service Accept message from a network; and considering a current data transfer via a control plane as successful based on the Service Accept message and not to initiate data transfer via Control Plane Cellular Internet of Things (CIoT) Evolved Packet System (EPS) Optimization while the control plane data back-off timer is running.

In another exemplary aspect of the disclosure, there is provided a communication system, comprising a User Equipment (UE) and a core network node, wherein the core network node is configured to transmit a control plane data back-off timer included in a Service Accept message to the UE, the UE is configured to: receive the control plane data back-off timer included in the Service Accept message, and consider a current data transfer via a control plane as successful based on the Service Accept message and not to initiate data transfer via Control Plane Cellular Internet of Things (CIoT) Evolved Packet System (EPS) Optimization while the control plane data back-off timer is running.

In another exemplary aspect of the disclosure, there is provided a communication method of a communication system including a User Equipment (UE) and a core network node, the communication method comprising: transmitting a control plane data back-off timer included in a Service Accept message from the core network node to the UE; and considering a current data transfer via a control plane as successful based on the Service Accept message and not initiating data transfer via Control Plane Cellular Internet of Things (CIoT) Evolved Packet System (EPS) Optimization while the control plane data back-off timer is running.

Aspects of the disclosure extend to corresponding systems, methods, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

FIG. 1 is a diagram illustrating mobile originated data transport via CIoT EPS Optimization.

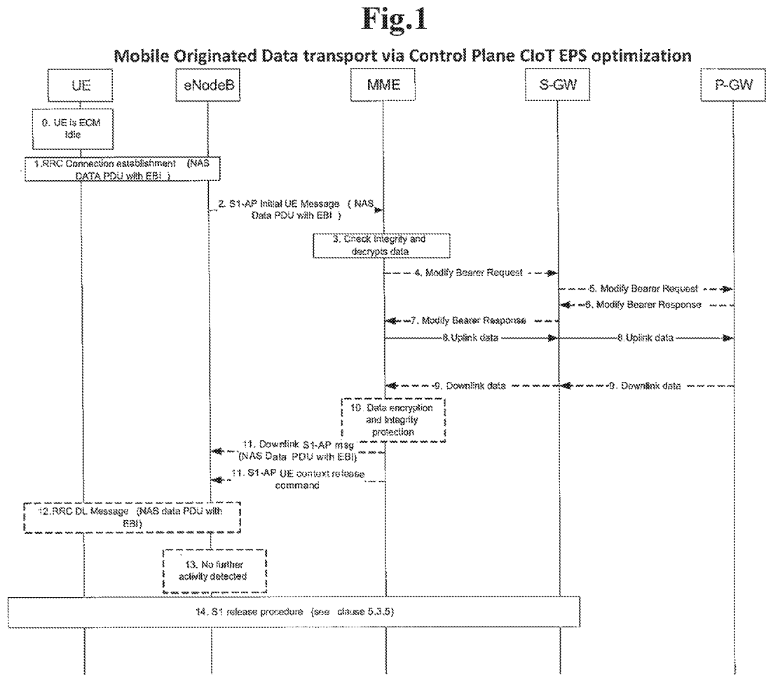

FIG. 2 is a diagram illustrating mobile terminated data transport via CIoT EPS Optimization.

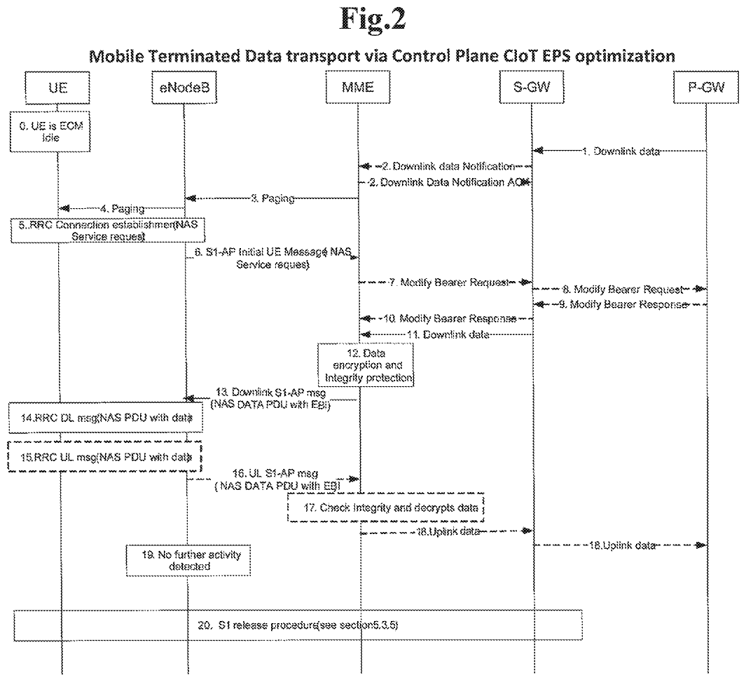

FIG. 3 is a diagram illustrating congestion from Control Plane data during the Attach/TAU/RAU procedures.

FIG. 4 is a diagram illustrating congestion from Control Plane data cause in the Service Accept.

FIG. 5 is a diagram illustrating congestion from Control Plane data in Service Reject and Control Plane Service Reject.

FIG. 6 is a diagram illustrating EPS Session Management (ESM) cause congestion from Control Plane data in Service Reject.

FIG. 7 is a diagram illustrating ESM cause congestion from Control Plane data in Service Reject.

FIG. 8 is a diagram illustrating a general communication system including UEs, a base station, a core network and an external IP network.

FIG. 9 is a diagram illustrating a UE.

FIG. 10 is a diagram illustrating a mobility management node or a Mobility Management Entity (MME) or a serving GPRS support node (SGSN).

FIG. 11 is a diagram illustrating a Service Capability Exposure Function (SCEF) or a Serving Gateway (S-GW).

### DESCRIPTION OF EMBODIMENTS

Each solution is described in a more specific embodiment as an example how to apply the invention to a 3GPP network. Even if the described solution is foreseen to be used in a 3GPP mobile network, using global system for mobile communications (GSM), GPRS, universal mobile telecommunications system (UMTS), high speed packet access (HSPA), LTE, LTE-Advanced (LTE-A) or New Radio access, but it is not limited to such a network and could be used in the same way for any other cellular or mobile network, e.g. CDMA2000, Bluetooth, IEEE 802.11 variants, ZigBee etc., i.e. any access technologies and core network technologies. The described protocol options are considered to be NAS, S1 application protocol (S1-AP), DIAMETER, GPRS Tunneling Protocol (GTP), mobile application part (MAP), session initiation protocol (SIP), but could be any other as well like hypertext transfer protocol (HTTP), Extensible Markup Language (XML) configuration access protocol (XCAP), remote authentication dial in user service (RADIUS), next generation non-access stratum (NG NAS), etc. The disclosure can be further mapped to the functional entities of the NextGen study for future 3GPP mobile networks in the following way:
eNB<=>New Radio Base Station (NR BS)
MME/SGSN<=>(Common) Control Plane Function, or a subfunction, e.g. Session Management Function, Mobility Management Function.
S-GW/P-GW<=>User Plane Function

Solution 1—New EMM/ESM Cause for Congestion from Control Plane Data

One possible solution to address the system (e.g. MME/SGSN) overload from excessive use of Control Plane CIoT EPS Optimization for data transfer, both for IP and non-IP data, is to introduce a new NAS level EPS Mobility Management (EMM)/ESM cause—Congestion from Control Plane data (or any other name that indicates a congestion from data transfer via Control Plane). The role of this new congestion cause is for the MME/SGSN to indicate to the UE a congestion from Control Plane data. This new congestion cause could be returned to the UE within the existing EMM cause/IE or ESM cause/IE or as a new cause/IE.

Below some use cases are described where this newly proposed Congestion from Control Plane data cause could be used.

Solution 1, Scenario A)—Congestion from Control Plane Data Cause Returned During Attach/TAU/RAU Procedures.

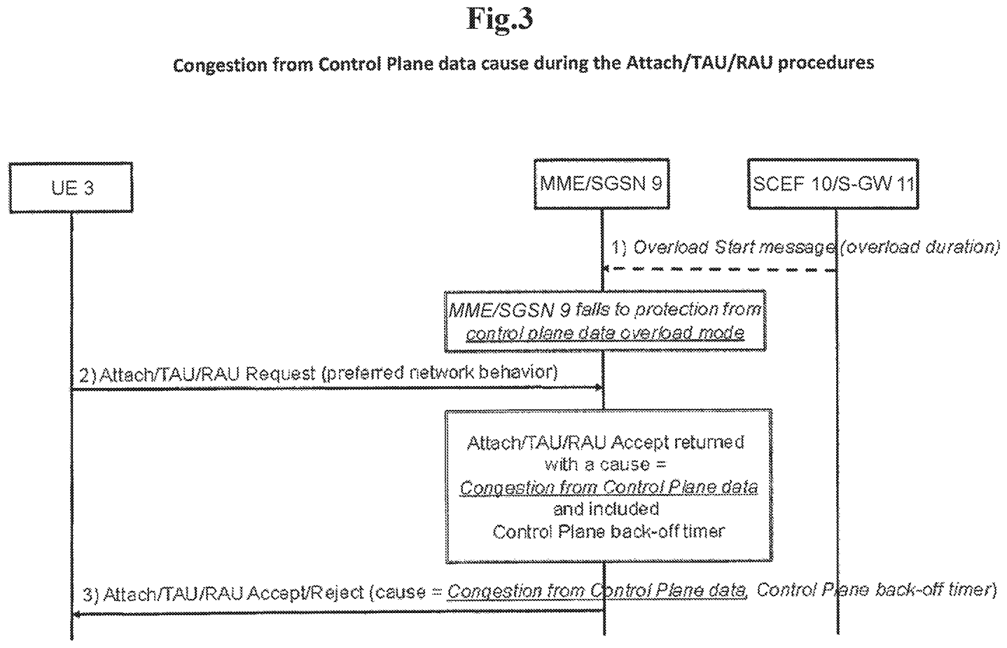

One possible scenario where the proposed new Congestion from Control Plane data cause can be used is during the Attach/TAU/RAU procedures (for example, as illustrated in FIG. 3).

1) At certain point, the MME/SGSN 9 or the network 7 in general may become overloaded or close to overload with control plane data or overloaded in general (e.g. the load reaches an operator defined threshold or the criteria for overload is simply based on an operator policy). A criterion for overload can also be an overload from control plane data indication received either from the connected SCEF 10 or from the S-GW 11/P-GW 12 (e.g. an Overload Start message or a Control Plane Overload Start message or any other name for the purpose of overload indication from the SCEF 10 or S-GW 11/P-GW 12 as shown in the FIG. 3. The SCEF 10/S-GW 11 may also indicate a proposed value for the duration (e.g a wait timer or a back-off timer or any other name for the duration of the overload) of the Control Plane data back-oft timer that the MME/SGSN 9 are likely to deploy as a result of the overload indication. When the criteria for overload from control plane data is fulfilled, the MME/SGSN 9 falls in a protection from control plane overload mode for the overload duration indicated by the SCEF 10/S-GW 11 or until Overload or a Control Plane Overload Stop message (or any other indication for the same purpose) is received from SCEF 10/S-GW 11.

2) The UE 3 initiates a registration or re-registration procedure by triggering the Attach/TAU/RAU Request message. In the Attach/TAU/RAU Request message, the UE 3 includes a Preferred Network Behavior parameter where the UE 3 indicates its support for Control Plane CIoT EPS Optimization and/or for User Plane CIoT EPS Optimization. The UE 3 also indicates it's preferred CIoT EPS Optimization (i.e. Control Plane CIoT EPS or User Plane CIoT EPS Optimization).

3) If the UE 3 indicated support and preference for Control Plane CIoT EPS Optimization and the MME/SGSN 9 and/or the network 7 is overloaded or close to overload (e.g. the MME/SGSN 9 has entered protection from control plane data overload mode), the MME/SGSN 9 may decide to respond with one of the following:
The MME/SGSN 9 accepts the registration request for Control Plane CIoT EPS Optimization, however, the MME/SGSN 9 may also return within the Attach/TAU/RAU Accept message an EMM or ESM cause (e.g. a Congestion from Control Plane data) to indicate that the MME/SGSN 9 or the network 7 as a whole is overloaded or close to overload with control plane data or in general. The MME/SGSN 9 may also include in the Attach/TAU/RAU Accept message a back-off timer (e.g. a Control Plane back-off timer) in order to restrict the UE 3 from coming for data transfer via Control Plane CIoT EPS Optimization for the duration of the included back-off timer. When deciding the duration for the Control Plane data back-off timer, the MME/SGSN 9 may take into account the overload duration indicated from SCEF 10/S-GW 11, if any. The new Congestion from Control Plane data cause or IE can be returned within the existing EMM or ESM cause/IE or as a new cause/IE. When the MME/SGSN 9 returns the Congestion from Control Plane data cause/IE within Attach/TAU/RAU Accept messages, the MME/SGSN 9 may also include a Control Plane data back-off timer. If so, the MME/SGSN 9 may store the returned Congestion from Control Plane data cause and the Control Plane back-off time per UE 3. The MME/SGSN 9 may immediately reject any subsequent request for data transfer via Control Plane CIoT EPS Optimization from the UE 3 before the stored Control Plane data back-off timer is expired;
The MME/SGSN 9 decides to accept the NAS registration request and indicates to the UE 3 that User Plane CIoT EPS Optimization has been selected (if the UE 3 has indicated a support for it) as the data transmission mechanism. Optionally the MME/SGSN 9 can indicate to the UE 3 the reason/cause why such decisions has been taken (e.g. a Congestion from Control Plane data) and possibly include a back-off timer (e.g. a Control Plane back-off timer). If a back-off timer is included, the UE 3 shall not initiated another registration request for Control Plane CIoT EPS Optimization while the back-off timer is running;
The MME/SGSN 9 may also reject the registration attempt by returning Attach/TAU/RAU Reject message, especially if the network 7 is overloaded for control plane data and the UE 3 indicated support for data transfer via control plane only. The MME/SGSN 9 may also return a rejection cause (e.g. a Congestion for Control Plane data) and may include a back-off timer (e,g. a Control Plane data back-off timer). If the Congestion from Control Plane data cause/IE and the Control Plane back-off timer are returned within the Attach/TAU/RAU Reject messages, the UE 3 shall not attempt another Attach/TAU/RAU with preference for Control Plane data while the Control Plane data back-off timer is running. However, the UE 3 can register for use of data transfer via User Plane CIoT EPS data.

The UE 3 that receives a Congestion from Control Plane data cause/IE (or any other new cause/IE designated for the purpose of indication for overload from Control Plane CIoT EPS Optimization) within the Attach/TAU/RAU Accept messages, the UE 3 shall start the included Control Plane data back-off timer and shall not send any NAS messages to the MME/SGSN 9 if a NAS data PDU with user data is included (e.g. a Control Plane Service Request message for data transfer via Control Plane CIoT EPS Optimization) for the duration of the Control Plane data back-off timer.

If the UE 3 receives a paging request from the MME/SGSN 9 while the Control Plane CIoT data back-off timer is running, the UE 3 shall answer the paging regardless of whether the Control Plane data back-off timer is running or not.

Solution 1, Scenario B)—Congestion from Control Plane Data Cause Returned Via Service Accept.

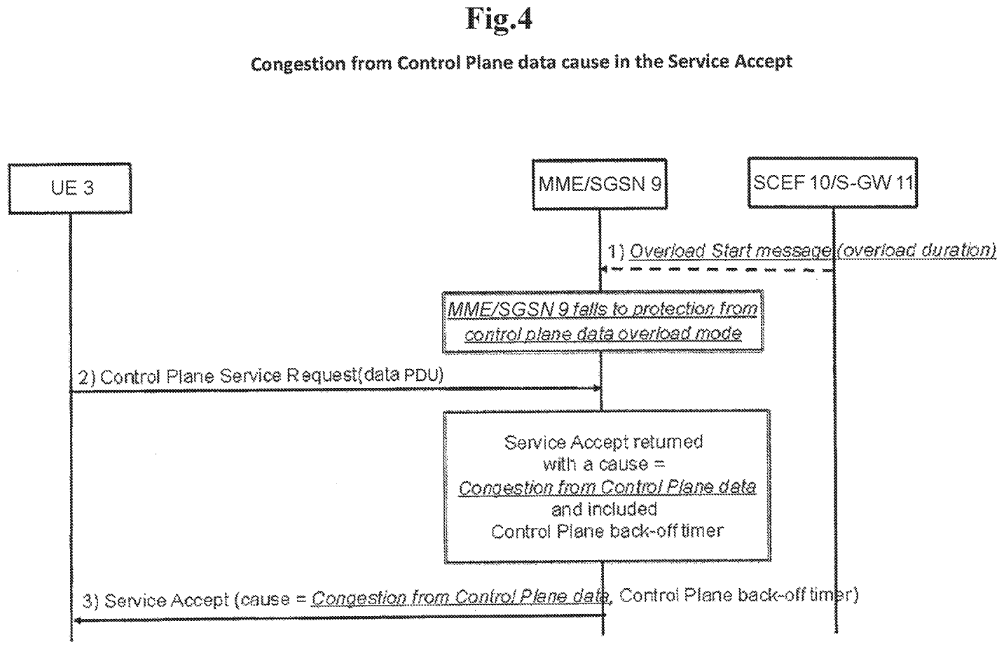

Another scenario where the proposed new Congestion from Control Plane data cause/IE can be used is during the Control Plane Service procedure where the Congestion from Control Plane data cause can be returned with the Service Accept message. This scenario is illustrated in FIG. 4,

1) At certain point, the MME/SGSN 9 or the network 7 in general may become overloaded or close to overload with control plane data or overloaded in general (e.g. the load reaches an operator defined threshold or the criteria for overload is simply based on an operator policy). A criterion for overload can also be an overload from control plane data indication received either from the connected SCEF 10 or from the S-GW 11/P-GW 12 (e.g. an Overload Start message or a Control Plane Overload Start message or any other message or indication for the purpose of overload indication from the SCEF 10 or S-GW 11/P-GW 12 as shown in the FIG. 4. The SCEF 10/S-GW 11 may also indicate a proposed value for the duration (e.g a wait timer or a back-off timer or any other name for the duration of the overload) of the Control Plane data back-oft timer that the MME/SGSN 9 are likely to deploy as a result of the overload indication. When the criteria for overload from control plane data is fulfilled, the MME/SGSN 9 falls in a protection from control plane overload mode for the overload duration indicated by the SCEF 10/S-GW 11 or until Overload or a Control Plane Overload Stop message (or any other indication for the same purpose) is received from SCEF 10/S-GW 11.

2) When an application in the UE 3 or the UE 3 itself requests a data transfer via control plane, the UE 3 initiates the Control Plane Service Request procedure by triggering the Control Plane Service Request message, see 3GPP TS 24.301. The UE 3 includes the data to be transferred in the Control Plane Service Request message (e.g. data PDU or NAS PDU) destined to the MME/SGSN 9.

3) The MME/SGSN 9 accepts the request for the data transfer via control plane and answers the UE 3 with a Service Accept message. Then the MME/SGSN 9 completes the transfer of the control plane data as per TS23.401. If the MME/SGSN 9 and/or the network 7 is overloaded or close to overload (e.g. the MME/SGSN has entered protection from control plane data overload mode), the MME/SGSN 9 may return within the Service Accept message a cause or IE (e.g. a Congestion from Control Plane data cause/IE). The MME/SGSN 9 may also include a Control Plane data back-off timer in order to restrict the UE 3 from coming back for data transfer via Control Plane CIoT EPS Optimization for the duration of this Control Plane data back-off timer. When deciding the duration for the Control Plane data back-off timer the MME/SGSN 9 may take into account the overload duration indicated from the SCEF 10/S-GW 11, if any. This new Congestion from Control Plane data cause or IE can be returned within the existing EMM cause/IE or ESM cause/IE or as a new cause/IE. When the MME/SGSN 9 indicated a Congestion from Control Plane data cause in a Service Accept message and included a Control Plane data back-off timer, the MME/SGSN 9 may store the Control Plane data back-off time per UE 3. The MME/SGSN 9 may immediately reject any subsequent new request for the data transfer via Control Plane CIoT EPS Optimization (e.g. the Control Plane Service Request or any other NAS message for the purpose of data transfer via control plane data) from the UE 3 before the stored Control Plane data back-off timer expires.

The UE 3 that receives a Congestion from Control Plane data cause/IE (or any other new cause/IE designated for the purpose of indication for overload from Control Plane CIoT EPS Optimization) within the Service Accept message and a Control Plane data back-off timer is included, the UE 3 shall finalise the already ongoing data transfer via control plane data and as soon as the UE 3 finishes the data transfer and falls back to the Idle Mode, the UE 3 shall start the included Control Plane data back-off timer and shall not send any NAS messages to the MME/SGSN 9 if a NAS data PDU with user data is included (e.g. a Control Plane Service Request message or any other message for the purpose for data transfer via Control Plane CIoT EPS Optimization) for the duration of the Control Plane data back-off timer.

If the UE 3 receives a paging request from the MME/SGSN 9 while the Control Plane CIoT data back-off timer is running, the UE 3 shall answer the paging regardless of whether the Control Plane data back-off timer is running or not.

Solution 1, Scenario C)—Congestion from Control Plane Data Cause Returned Via Service Reject or Control Plane Service Reject.

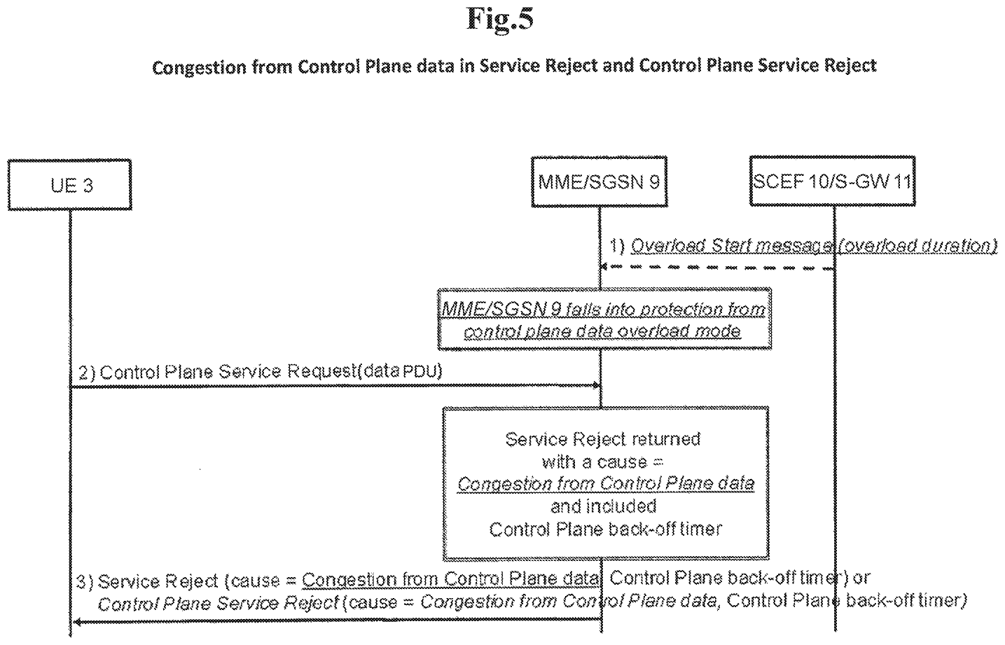

Another scenario where the proposed new Congestion from Control Plane data cause/IE can be used is during the Control Plane Service procedure where the Congestion from Control Plane data cause can be returned with the existing Service Reject message or in a new Control Plane Service Reject message. This scenario is illustrated in FIG. 5.

1) At certain point, the MME/SGSN 9 or the network 7 in general may become overloaded or close to overload with control plane data or overloaded in general (e.g. the load reaches an operator defined threshold or the criteria for overload is simply based on an operator policy). A criteria for overload can also be an overload from control plane data indication received either from the connected SCEF 10 or from the S-GW 11/P-GW 12 (e.g. an Overload Start message or a Control Plane Overload Start message or any other message or indication for the purpose of overload indication from the SCEF 10 or S-GW 11/P-GW 12 as shown in the FIG. 5. The SCEF 10/S-GW 11 may also indicate a proposed value for the duration (e.g. a wait timer or a back-off timer or any other name for the duration of the overload) of the Control Plane data back-oft timer that the MME/SGSN 9 are likely to deploy as a result of the overload indication. When the criteria for overload from control plane data is fulfilled, the MME/SGSN 9 falls in a protection from control plane overload mode for the overload duration indicated by the SCEF 10/S-GW 11 or until Overload or a Control Plane Overload Stop message (or any other indication for the same purpose) is received from the SCEF 10/S-GW 11.

2) When an application in the UE 3 or the UE 3 itself requests a data transfer via control plane, the UE 3 initiates the Control Plane Service Request procedure by triggering the Control Plane Service Request message. The UE 3 includes the user data to be transferred in the Control Plane Service Request message (e.g. data PDU or NAS PDU) destined to the MME/SGSN 9.

3) If the MME/SGSN 9 and/or the network 7 is overloaded or close to overload (e.g. the MME/SGSN 9 has entered protection from control plane data overload mode), the MME/SGSN 9 may reject the request for the data transfer via control plane by the UE 3 by returning a Service Reject message or a new message called Control Plane Service Reject message, for example or any other name for the purpose of rejecting a request for data transfer via control plane). The MME/SGSN 9 may also return within the reject message a new cause (e.g. a Congestion from Control Plane data or any other name that indicates a congestion from data transfer via control plane). This new Congestion from Control Plane data cause or IE can be returned within the existing EMM cause/IE or ESM cause/IE or as a new cause/IE. The MME/SGSN 9 may also include a Control Plane data back-off timer in order to restrict the UE 3 from coming back for data transfer via Control Plane CIoT EPS Optimization for the duration of this Control Plane data back-off timer. When deciding the duration for the Control Plane data back-off timer the MME/SGSN 9 may take into account the overload duration indicated from the SCEF 10/S-GW 11, if any. When the MME/SGSN 9 indicated a Congestion from Control Plane data cause and included a Control Plane data back-off timer, MME/SGSN 9 may store the Congestion from Control Plane data cause and the Control Plane data back-off timer per UE 3. The MME/SGSN 9 may reject any subsequent request for data transfer via Control Plane CIoT EPS Optimization (i.e. Control Plane Service Request or any other NAS message for the purpose of data transfer via Control Plane CIoT Optimization) from the UE 3 before the stored Control Plane data back-off timer expires.

The UE 3 that receives a Congestion from Control Plane data cause/IE (or any other new cause/IE designated for the purpose of indication for overload from Control Plane CIoT EPS Optimization) within the Service Reject message or with a new Control Plane Service Reject message or any other name with the purpose of rejection a request for data transfer via control plane shall drop the ongoing data transfer via control plane. If a Control Plane data back-off timer is included, the UE 3 shall start the Control Plane data back-off timer and shall not send any NAS messages to the MME/SGSN 9 if a NAS data PDU with user data is included (e.g. a Control Plane Service Request message or any other message for the purpose for data transfer via Control Plane CIoT EPS Optimization) for the duration of the Control Plane data back-off timer.

Common UE Behavior while the Control Plane Back-Off Timer is Running

If a UE 3 receives a Congestion from Control Plane data cause and a Control plane data back-off timer or only the Control Plane back-off timer via one of the above listed scenarios in Solution 1 and the UE 3 has started the Control Plane back-off timer:
If the UE 3 is configured to send exception reporting by the network 7, the UE 3 may initiate data transfer via Control Plane CIoT EPS Optimization (e.g. a Control Plane Service Request message or any other message for the purpose of data transfer via Control Plane CIoT EPS Optimization) for exception reporting even if the Control Plane data back-off timer is running.
While the Control Plane data back-off timer is running, the UE 3 shall not initiate any request for data transfer via Control Plane CIoT EPS Optimization except for high priority access, emergency services and mobile terminated services.
While the Control Plane data back-off timer is running, the UE 3 is allowed to initiate data transfer via User Plane CIoT EPS Optimization.
The Control Plane data back-off timer shall continue running if UE 3 moves to another cell or RAT.
The Control Plane data back-off timer shall be stopped after successful TAU/RAU with MME/SGSN change.
The Control Plane data back-off timer is stopped when a new public land mobile network (PLMN) is accessed.
The Control Plane data back-off timer shall not restrict the sending and receiving of the SMS services.
The Control Plane data back-off timer in the UE 3 and in the network 7 shall be running independently from the other NAS level back-off timers like NAS level Mobility back-off time, ESM back-off timer or Access Point Name (APN) back-off timer.

Solution 2—New Congestion from Control Plane Data Per Bearer

Another possibility to control the congestion from control plane data is to apply congestion control for a particular bearer

Solution 2, Scenario A)—ESM Congestion from Control Plane Data Cause Towards SCEF.

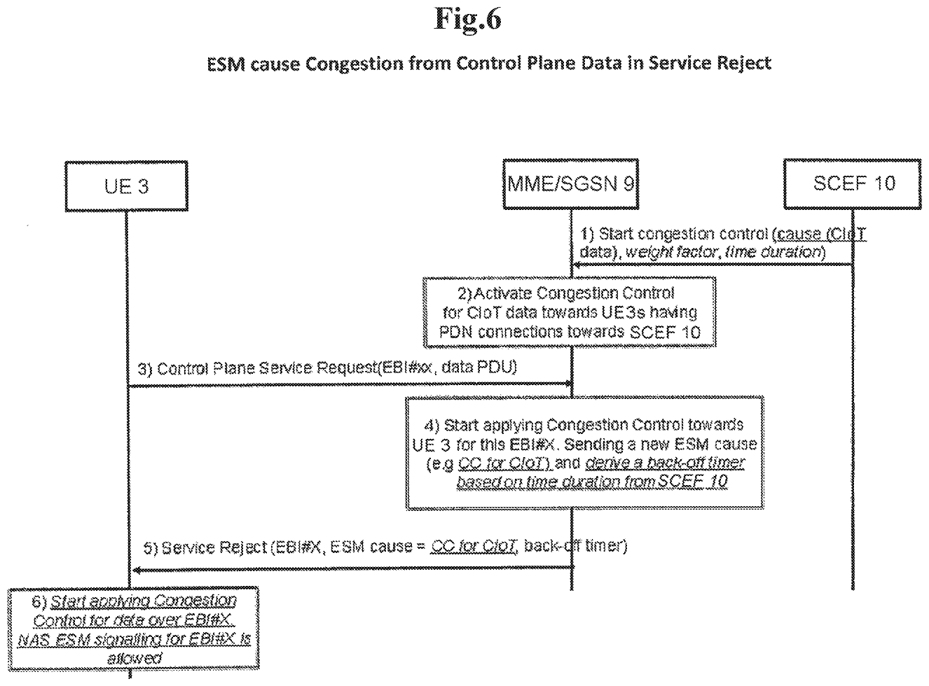

One possible solution to control the overload from Control Plane data (CIoT or any other type of data) for non-IP data via SCEF 10 is to introduce an ESM cause for congestion control per bearer or per SCEF 10, for example, as illustrated in FIG. 6.

1) When an SCEF 10 gets congested, the SCEF 10 indicates a Start Congestion Control message to MME/SGSN 9. The SCEF 10 may include in this message a congestion from control plane data cause, a weight factor and a time duration.

2) When the MME/SGSN 9 receives the Start Congestion Control message from the SCEF 10 with the congestion from control plane cause indication, the MME/SGSN 9 activates congestion control for CIoT data towards the UE 3s having PDN connections towards the SCEF 10 performing step 1.

3) At some point, the UE 3 may initiate a request for control Plane data transfer on a specific bearer by sending a Control Plane Service Request message towards the MME/SGSN 9. The UE 3 may include the bearer identity (e.g. EPS Bearer ID (EBI)) along with the data for transfer in the ESM container.

4) The MME/SGSN 9 starts applying the congestion control towards the UE 3 for the bearer identity received by the UE 3 and derives a back-off timer based on the time duration from the SCEF 10

5) The MME/SGSN 9 then returns a Service Reject message towards the UE 3 and includes an EMM failure cause (Congestion Control (CC) for CIoT) together with the EBI# and a back-off timer derived from the duration parameter received by the SCEF 10. Alternatively, the MME/SGSN 9 sends a Service Reject message towards the UE 3 which includes a NAS ESM message encapsulated in the Service Request message and this NAS ESM message contains a new ESM cause (CC for CIoT) and the back-off timer derived from the duration parameter received by the SCEF 10.

6) When the UE 3 receives the Service Reject message with the new EMM or ESM cause (CC for CIoT) according to step S), the UE 3 starts applying congestion control for data over EBI#X. NAS ESM signaling for EBI#X is allowed.

Solution 2, Scenario B)—ESM Congestion from Control Plane Data Cause Towards SGi.

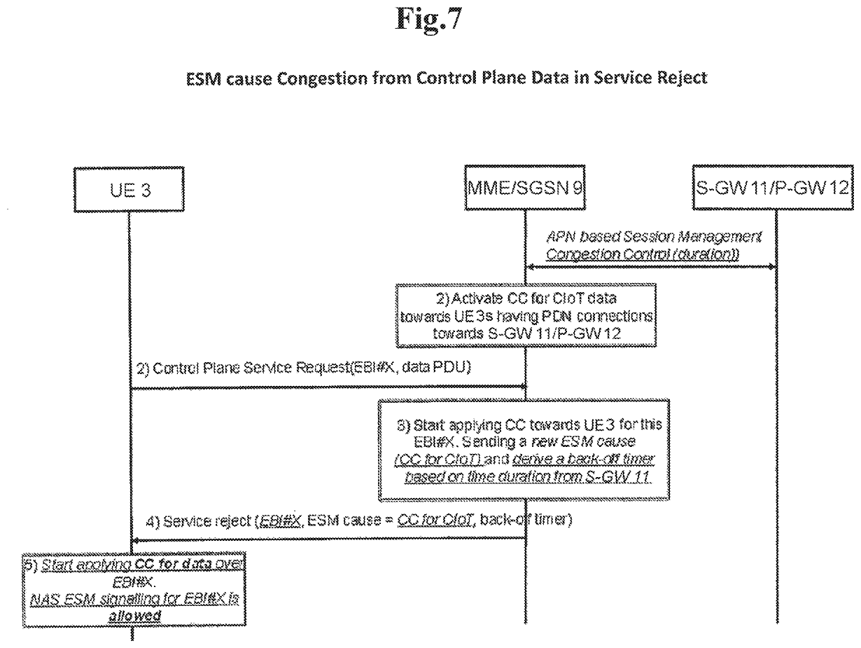

Another possible solution to control the overload from Control Plane data (CIoT or any other type of data) for IP and non-IP data via SGi is to introduce an ESM cause for congestion control per bearer or PDN connection towards the SGi. This is illustrated in FIG. 7.

1) When the P-GW 12 gets congested from control plane data, the P-GW 12 triggers the Start Congestion Control procedure by indication for control plane congestion to the S-GW 11. The P-GW 12 may include in this message a congestion from control plane data cause, a weight factor and a time duration. The S-GW 11 further indicates a congestion from control plane data towards the MME/SGSN 9.

2) When the MME/SGSN 9 receives an indication from control plane data (e.g. a Start Congestion Control message or any other message for the same purpose) from the S-GW 11, the MME/SGSN 9 activates congestion control for CIoT data towards UEs 3 having PDN connections towards the SCEF 10.

3) At some point, the UE 3 may initiate a request for control plane data transfer towards SGi on specific bearer by sending a Control Plane Service Request message towards the MME/SGSN 9. The UE 3 may include the bearer identity (e.g. EBI) along with the data for transfer in the ESM container.

4) The MME/SGSN 9 starts applying the congestion control towards the UE 3 for the bearer identity received by the UE 3 and derives a back-off timer based on the time duration from the P-GW 12.

5) The MME/SGSN 9 then returns a Service Reject message towards the UE 3 and includes a new ESM cause (CC for CIoT) and the back-off timer derived from the duration parameter received by the P-GW 12.

6) When the UE 3 receives the Service Reject message with the new ESM cause (CC for CIoT), the UE 3 starts applying congestion control for data over EBI#X. NAS ESM signalling for EBI#X is allowed.

### SUMMARY

Beneficially, the above described exemplary embodiments include, although they are not limited to, one or more of the following functionalities.

Solution 1:
Congestion from Control Plane data cause—a new Congestion from Control Plane data cause (or any other cause/name for the purpose if indication of overload from control plane data) within EMM cause/IE or ESM cause/IE or as a new cause/IE returned to the UE 3 when the network 7 is overloaded or close to overload from Control Plane data or overloaded in general (e.g. the network 7 is in protection from control plane data overload mode) with the purpose to restrict any further attempts for data transfer via Control Plane CIoT EPS Optimization. The new Congestion from Control Plane data cause could be returned to UE 3 within any existing or a new NAS message (e.g. an Attach/TAU/RAU Accept/Reject message, Service Accept/Reject message and more). The MME/SGSN 9 may include a Control Plane data back-off timer and if so, the UE 3 should not come back with another attempt for data transfer via control plane data until the Control Plane data back-off timer expires.
Overload Start/Stop message—a new Overload Start and Overload Stop messages (or any other message/name for the purpose of indication of overload from control plane data) from the SCEF 10 to MME/SGSN 9 and from the S-GW 11/P-GW 12 to the MME/SGSN 9 for indication of overload from Control Plane data. The Overload Start message may also indicate the expected overload duration which may be considered by the MME/SGSN 9 when setting a value for the Control Plane data back-off timer.
Control Plane Service Reject message—a new message Control Plane Service Reject message for the purpose of rejecting a request by the UE 3 for data transfer via Control Plane CIoT EPS Optimization (i.e. via a Control Plane Service Request message). When the MME/SGSN 9 is overloaded or close to overload (e.g. the network 7 is in protection from control plane data overload mode), the MME/SGSN 9 may decide to reject a request by the UE 3 for data transfer via control plane data by returning the Service Reject message. The MME/SGSN 9 may include a Control Plane data back-off timer and if so, the UE 3 should not come back with another attempt for data transfer via control plane data until the Control Plane data back-off timer expires.
EMM/ESM causes/IEs in new messages—the existing EMM/ESM cause/IE are proposed to be used in new messages like a Service Accept message. a TAU Accept message, a RAU Accept message, an Attach accept message, and etc.

Solution 2:
Congestion Control ESM cause per PDN connection/EPS bearer toward the SCEF 10—a new Congestion Control ESM cause for congestion control over specific PDN connection/EPS bearer towards the SCEF 10.
Congestion Control ESM cause per PDN connection/EPS bearer towards P-GW 12—a new Congestion Control ESM cause for congestion control over specific PDN connection/EPS bearer towards the SCEF 10.

It can be seen that the above embodiments describe the features of:
Overload Start and Overload Stop messages (or any other message/name for the purpose of indication of overload from control plane data) from the SCEF 10 to the MME/SGSN 9 and from the S-GW 11/P-GW 12 to the MME/SGSN 9 for indication of overload from Control Plane data. The new Overload Start message from the SCEF 10 or S-GW 11 to the MME/SGSN 9 may also indicate the expected overload duration which may be considered by the MME/SGSN 9 when setting a value for:
   the Control Plane data back-off timer to be returned to the UEs 3 in a NAS messages (e.g. an Attach/TAU/RAU Accept/Reject message and a Service Accept/Reject message); and
   the Control Plane overload indication to be indicated to the Radio Access Network (RAN) Nodes (e.g. eNB) 5 in the Overload Start message.
A Congestion from Control Plane data cause (or any other cause/name for the purpose of indication of overload from control plane data) within an EMM cause/IE or an ESM cause/IE or as a new cause/IE returned to the UE 3 in a NAS message (an Attach/TAU/RAU Accept/Reject message and a Service Accept/Reject message) when the network 7 is overloaded or close to overload from Control Plane data or in general (e.g. the network 7 is in protection from control plane data overload mode) with the purpose to restrict any further attempts for data transfer via Control Plane CIoT EPS Optimization.

It can be seen that the above embodiments beneficially provide a number of benefits, including (but not limited to) network overload protection from control plane data.

System Overview

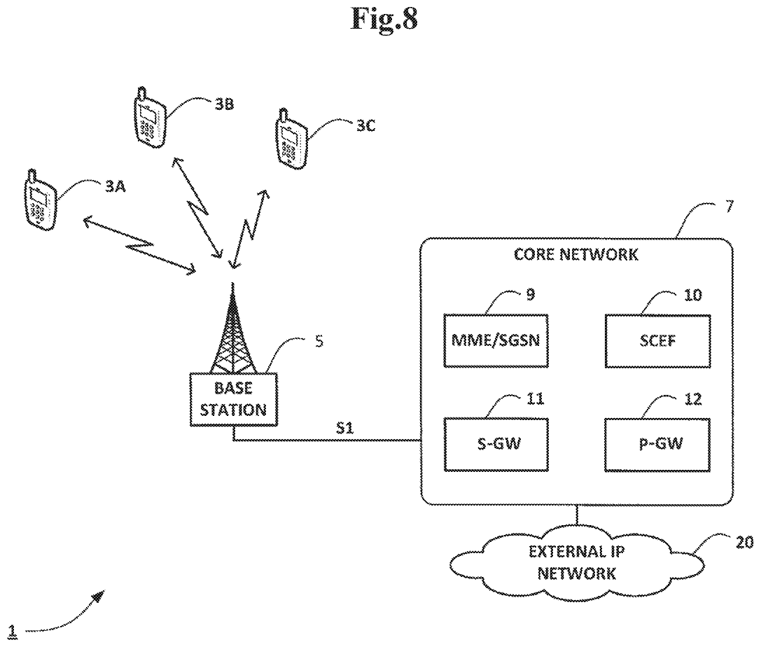

FIG. 8 schematically illustrates a mobile (cellular or wireless) telecommunication system 1 in which users of mobile devices 3A to 3C can communicate with each other and other users via respective base stations 5 and a core network 7 using an Evolved Universal Terrestrial Radio Access (E-UTRA) radio access technology (RAT). As those skilled in the art will appreciate, whilst three mobile devices 3 and one base station 5 are shown in FIG. 8 for illustration purposes, the system, when implemented, will typically include other base stations and mobile devices.

As is well known, a mobile device 3 may enter and leave the areas (i.e. radio cells) served by the base stations 5 as the mobile device 3 is moving around in the geographical area covered by the telecommunication system 1. In order to keep track of the mobile device 3 and to facilitate movement between the different base stations 5, the core network 7 comprises at least one mobility management entity (MME) 9. In some core networks, an SGSN may be used instead of the MME.

The MME/SGSN 9 is in communication with the base station 5 coupled to the core network 7. The core network 7 also includes an SCEF 10, and one or more gateways, such as a serving gateway (S-GW) 11 and/or a packet data network gateway (P-GW) 12. Although shown separately, it will be appreciated that the functionalities of the S-GW 11 and the P-GW 12 may be provided by a single network entity, if appropriate.

The mobile devices 3 and their respective serving base stations 5 are connected via an LTE air interface, the so-called “Uu” interface. Neighbouring base stations 5 are connected to each other via a so-called “X2” interface (not shown in FIG. 8). The base station 5 is also connected to the core network nodes (such as one of the MMEs/SGSNs 9 and the S-GW 11) via a so-called “S1” interface. From the core network 7, connection to an external IP network 20, such as the Internet, is also provided via the P-GW 12. Although not shown in FIG. 8, the core network may also include further nodes, such as a home subscriber server (HSS) and/or the like.

User Equipment (UE)

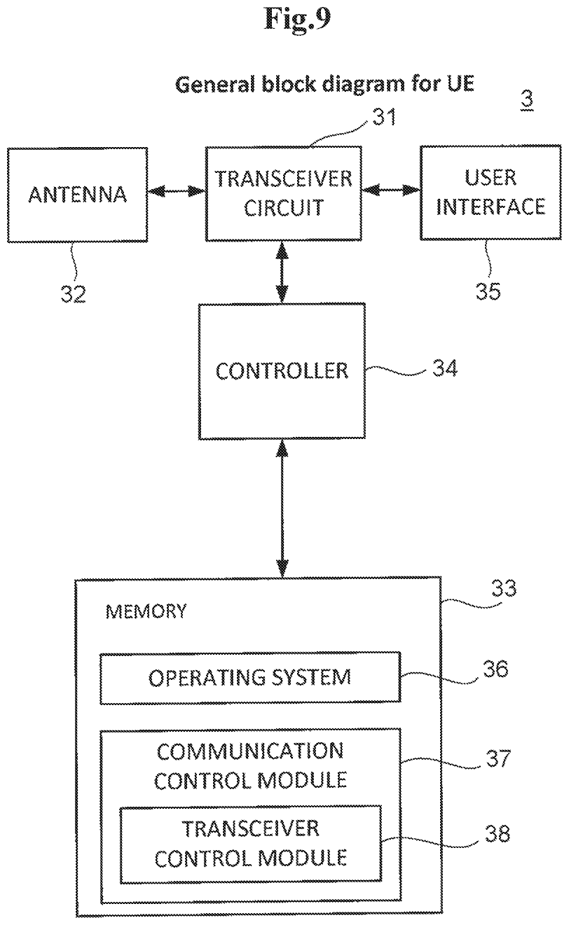

FIG. 9 is a block diagram illustrating the main components of the UE 3. As shown, the UE 3 includes a transceiver circuit 31 which is operable to transmit signals to and to receive signals from the connected node(s) via one or more antenna 32. The UE 3 will of course have all the usual functionality of a conventional mobile device (such as a user interface 35) and this may be provided by any one or any combination of hardware, software and firmware, as appropriate. Software may be pre-installed in a memory 33 and/or may be downloaded via the telecommunication network or from a removable data storage device (RMD), for example. A controller 34 controls the operation of the UE 3 in accordance with software stored in the memory 33. The software includes, among other things, an operating system 36 and a communications control module 37 having at least a transceiver control module 38. The communications control module 37 (using its transceiver control module 38) is responsible for handling (generating/sending/receiving) signaling between the UE 3 and other nodes, such as the base station (eNodeB) 5 and the MME/SGSN 9. Such signaling may include, for example, appropriately formatted signaling messages relating to an Attach/TAU/RAU procedure with the network and/or overload control.

MME/SGSN

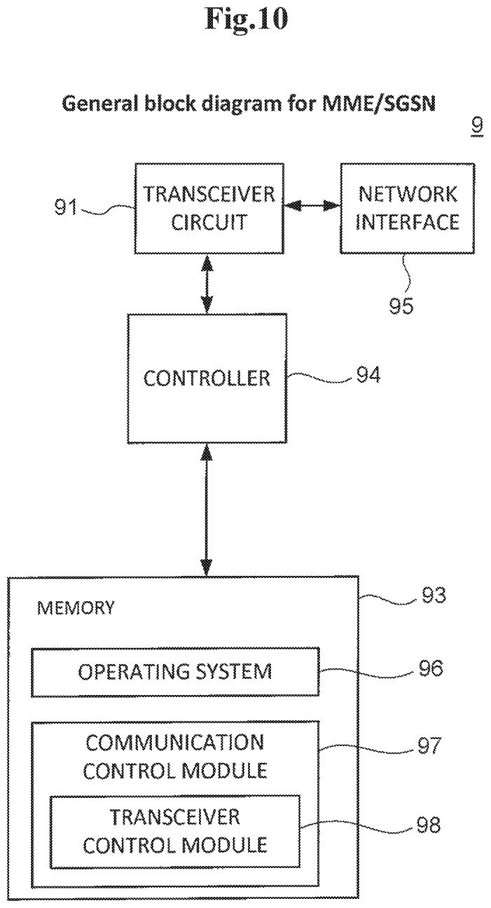

FIG. 10 is a block diagram illustrating the main components of the MME/SGSN 9. As shown, the MME/SGSN 9 includes a transceiver circuit 91 which is operable to transmit signals to and to receive signals from other nodes (including the UE 3) via a network interface 95. A controller controls the operation of the MME/SGSN 9 in accordance with software stored in a memory 93. Software may be pre-installed in the memory 93 and/or may be downloaded via the telecommunication network or from a removable data storage device (RMD), for example. The software includes, among other things, an operating system 96 and a communications control module 97 having at least a transceiver control module 98. The communications control module 97 (using its transceiver control module 98) is responsible for handling (generating/sending/receiving) signaling between the MME/SGSN 9 and other nodes, such as the UE 3, the SCEF 10, and the S-GW 11. Such signaling may include, for example, appropriately formatted signaling messages relating to an Attach/TAU/RAU procedure (for a particular UE 3) and/or overload control.

SCEF/S-GW

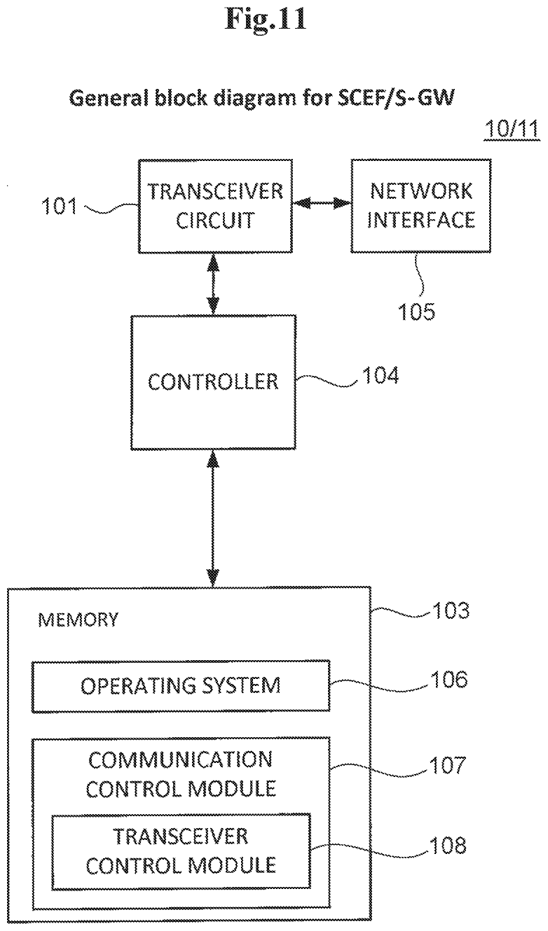

FIG. 11 is a block diagram illustrating the main components of an exemplary SCEF 10 or S-GW 11. As shown, the SCEF 10/S-GW 11 includes a transceiver circuit 101 which is operable to transmit signals to and to receive signals from other nodes connected to the SCEF 10/S-GW 11 (such as the MME/SGSN 9) via a network interface 105. A controller 104 controls the operation of the SCEF 10/S-GW 11 in accordance with software stored in a memory 103. Software may be pre-installed in the memory 103 and/or may be downloaded via the telecommunication network or from a removable data storage device (RMD), for example. The software includes, among other things, an operating system 106 and a communications control module 107 having at least a transceiver control module 108. The communications control module 107 (using its transceiver control module 108) is responsible for handling (generating/sending/receiving) signaling between the SCEF 10/S-GW 11 and other network nodes (such as the MME/SGSN 9). The signaling may include, for example, appropriately formatted signaling messages relating to overload control.

Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

In the above description, the UE 3, the MME/SGSN 9, and the SCEF 10/S-GW 11 are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs); input/output (JO) circuits; internal memories/caches (program and/or data); processing registers; communication buses (e.g. control, data and/or address buses); direct memory access (DMA) functions; hardware or software implemented counters, pointers and/or timers; and/or the like.

In the above embodiments, a number of software modules were described. As those skilled in the art will appreciate, the software modules may be provided in compiled or un-compiled form and may be supplied to the UE 3, the MME/SGSN 9, and the SCEF 10/S-GW 11 as a signal over a computer network, or on a recording medium. Further, the functionality performed by part or all of this software may be performed using one or more dedicated hardware circuits. However, the use of software modules is preferred as it facilitates the updating of the UE 3, the MME/SGSN 9, and the SCEF 10/S-GW 11 in order to update their functionalities.

In the above embodiments, a 3GPP radio communications (radio access) technology is used. However, any other radio communications technology (e.g. WLAN, Wi-Fi, WiMAX, Bluetooth, etc.) may also be used in accordance with the above embodiments. The above embodiments are also applicable to ‘non-mobile’ or generally stationary user equipment.

Examples of IoT Applications

Some examples of Internet of Things (or MTC) applications are listed in the following table (source: 3GPP TS 22.368 V 13.1.0, Annex B). This list is not exhaustive and is intended to be indicative of the scope of Internet of Things/machine-type communication applications.

TABLE 1

| Service Area | IoT applications |
|---|---|
| Security | Surveillance systems |
| | Backup for landline |
| | Control of physical access (e.g. to buildings) |
| | Car/driver security |
| Tracking & Tracing | Fleet Management |
| | Order Management |
| | Pay as you drive |
| | Asset Tracking |
| | Navigation |
| | Traffic information |
| | Road tolling |
| | Road traffic optimisation/steering |
| Payment | Point of sales |
| | Vending machines |
| | Gaming machines |
| Health | Monitoring vital signs |
| | Supporting the aged or handicapped |
| | Web Access Telemedicine points |
| | Remote diagnostics |
| Remote | Sensors |
| Maintenance/Control | Lighting |
| | Pumps |
| | Valves |
| | Elevator control |
| | Vending machine control |
| | Vehicle diagnostics |
| Metering | Power |
| | Gas |
| | Water |
| | Heating |
| | Grid control |
| | Industrial metering |
| Consumer Devices | Digital photo frame |
| | Digital camera |
| | eBook |

Various other modifications will be apparent to those skilled in the art and will not be described in further detail here.

Abbreviations and Terminology

The following abbreviations and terminology (whenever differently stated) are used in the current document:

TABLE 2

| | |
|---|---|
| 3GPP | 3^{rd} Generation Partnership Project |
| APN | Access Point Name |
| AS | Access Stratum |
| CIoT | Cellular Internet of Things |
| EMM | EPS Mobility Management |
| EPS | Evolved Packet System |
| ESM | EPS Session management |
| E-UTRAN | Evolved Universal Terrestrial Radio Access Network |
| | (also used as EUTRAN) |
| GPRS | General Packet Radio Service |
| GTP | GPRS Tunneling Protocol |
| GUTI | Globally Unique Temporary ID |
| HPLMN | Home Public Land Mobile Network |
| HSS | Home Subscriber Server |
| IE | Information Element |
| MME | Mobility Management Entity |
| MNO | Mobile Network Operator |
| NAS | Non Access Stratum |
| NB, eNB | Node B, evolved Node B (but can also be any ‘RAN node’ |
| | implementing 2G, 3G, 4G, or future 5G technology) |
| NIDD | Non-IP Data Delivery |
| PGW | Packet Data Network Gateway |
| PDN | Packet Data Networks |
| PDU | Protocol Data Unit |
| RAU | Routing Area Update |
| RNC | Radio Network Controller |
| RRC | Radio Resource Control |
| PLMN | Public Land Mobile Network |
| S1-U | Reference point between E-UTRAN and Serving GW |
| S1AP | S1 Application Protocol |
| SCEF | Service Capability Exposure Function |
| SGSN | Serving GPRS Support Node |
| S-GW | Serving Gateway |
| SMS | Short Message Service |
| TAU | Tracking Area Update |
| UE | User Equipment |
| UTRAN | UMTS Terrestrial Radio Access Network |

In addition, the following terminologies are used within this document:

Cellular IoT: Cellular network supporting low complexity and low throughput devices for a network of Things. Cellular IoT supports both IP and Non-IP traffic.

Narrowband-IoT (NB-IoT): a 3GPP Radio Access Technology that forms part of Cellular IoT. The Narrowband-IoT allows access to network services via E-UTRA with a channel bandwidth limited to 180 kHz (corresponding to one Physical Resource Block (PRB)). Unless otherwise indicated in a clause or sub-clause, Narrowband-IoT is a subset of the Evolved Universal Terrestrial Radio Access Network (E-UTRAN).

WB-E-UTRAN: Wide Band (WB)-E-UTRAN is the part of the E-UTRAN that excludes the NB-IoT

Control Plane CIoT EPS Optimization—support of infrequent small data transmission (for IP data, non-IP data and SMS) via optimized Control Plane signalling. Mandatory for UE 3 and the network.

User Plane CIoT EPS Optimization—support of infrequent small data transmission (for IP data and SMS) via optimized User Plane. Optional for both the UE 3 and the network.

This application is based upon and claims the benefit of priority from European patent application No. 16193159.7 filed on Oct. 10, 2016, the disclosure of which is incorporated herein in its entirety by reference.

1-30. (canceled)

31. A UE (User Equipment), comprising:
a memory storing instructions; and
at least one processor configured to process the instructions to:
receive a control plane data back-off timer included in a Service Accept message from a network, and
consider a current data transfer via a control plane as successful based on the Service Accept message and not to initiate data transfer via Control Plane CIoT (Cellular Internet of Things) EPS (Evolved Packet System) Optimization while the control plane data back-off timer is running.

32. The UE according to claim 31, wherein the at least one processor is further configured to process the instructions to:
receive the control plane data back-off timer included in a Service Reject message from the network, and
consider the current data transfer via the control plane as unsuccessful based on the Service Reject message including a congestion cause and not to initiate data transfer via the Control Plane CIoT EPS Optimization while the control plane data back-off timer is running.

33. The UE according to claim 31, wherein the at least one processor is further configured to process the instructions to initiate user data transmission via the Control Plane CIoT EPS Optimization for at least one of high priority access, emergency services and mobile terminated services while the control plane data back-off timer is running.

34. The UE according to claim 31, wherein the at least one processor is further configured to process the instructions to stop the control plane data back-off timer at PLMN change

35. The UE according to claim 31, wherein the at least one processor is further configured to process the instructions to stop the control plane data back-off timer after successful Tracking Area Update procedure.

36. The UE according to claim 31, wherein the at least one processor is further configured to process the instructions to continue running the control plane data back-off timer when the UE moves to another cell.

37. A communication method of a UE (User Equipment), comprising:
receiving a control plane data back-off timer included in a Service Accept message from a network; and
considering a current data transfer via a control plane as successful based on the Service Accept message and not to initiate data transfer via Control Plane CIoT (Cellular Internet of Things) EPS (Evolved Packet System) Optimization while the control plane data back-off timer is running.

38. The communication method according to claim 37, further comprising:
receiving the control plane data back-off timer included in a Service Accept message from the network; and
considering the current data transfer via the control plane as unsuccessful based on the Service Reject message including a congestion cause and not to initiate data transfer via the Control Plane CIoT EPS Optimization while the control plane data back-off timer is running.

39. The communication method according to claim 37, further comprising:
initiating user data transmission via the Control Plane CIoT EPS Optimization for at least one of high priority access, emergency services and mobile terminated services while the control plane data back-off timer is running.

40. The communication method according to claim 37, further comprising:
stopping the control plane data back-off timer at PLMN change.

41. The communication method according to claim 37, further comprising:
stopping the control plane data back-off timer after successful Tracking Area Update procedure.

42. The communication method according to claim 37, further comprising:
continuing running the control plane data back-off timer when the UE moves to another cell.

43. A communication system, comprising:
a User Equipment (UE); and
a core network node, wherein
the core network node is configured to transmit a control plane data back-off timer included in a Service Accept message to the UE,
the UE is configured to:
receive the control plane data back-off timer included in the Service Accept message, and
consider a current data transfer via a control plane as successful based on the Service Accept message and not to initiate data transfer via Control Plane CIoT (Cellular Internet of Things) EPS (Evolved Packet System) Optimization while the control plane data back-off timer is running.
